(19) United States
(12) Patent Application Publication
(10) Pub. No.: US 2020/0072551 A1
(43) Pub. Date: Mar. 5, 2020

(54) SYSTEMS AND METHODS FOR PROCESSING AN AGRICULTURAL PRODUCT

(71) Applicant: CANOPY GROWTH CORPORATION, SMITHS FALLS (CA)

(72) Inventors: JAMES BOIRE, SASAKATOON (CA); TYLER CALOW, SASKATOON (CA); JASON GREEN, HAGEN (CA); TYLER JAMES JOHNSON, STURGEON COUNTY (CA); MATTHEW JOHNSTON, LANGHAM (CA); JAYSON KOROLL, SASKATOON (CA); FRANK MONSMAN, SASKATOON (CA); MYLES NEMETCHEK, SASKATOON (CA); LEON PRATCHLER, SASKATOON (CA); MICHAEL SCHUSTER, SASKATOON (CA); JOHN WARNER, ROSSEAU (CA)

(21) Appl. No.: 16/551,819

(22) Filed: Aug. 27, 2019

Related U.S. Application Data
(60) Provisional application No. 62/724,350, filed on Aug. 29, 2018.
(60) Provisional application No. 62/728,357, filed on Sep. 7, 2018.
(60) Provisional application No. 62/750,940, filed on Oct. 26, 2018.

(51) Int. Cl. F26B 25/22; F26B 21/00

(52) U.S. Cl. CPC F26B 25/22; F26B 9/06; F26B 21/002

(57) ABSTRACT

A drying system having a container, an air system, a sensor, and a control system. The control system is programmed to receive a measurement from the sensor and generate an air system instruction based on the measurement. The air system instruction corresponds with at least one of the temperature, flow rate, and/or pressure of airflow directed to the container by the air system. The air system adjusts the temperature, flow rate, and/or pressure of the airflow based on the air system instruction generated by the control system. A process for drying an agricultural product. A drying system having a floor with apertures that are sized and spaced so that a volumetric flow rate of the airflow through the apertures is between 75% to 100% of a maximum volumetric flow rate of the air system.

### CROSS-REFERENCE TO RELATED APPLICATIONS

This application is based on and claims priority to U.S. Provisional Application Ser. No. 62/724,350, filed on Aug. 29, 2018; and U.S. Provisional Application Ser. No. 62/728,357, filed on Sep. 7, 2018; and U.S. Provisional Application Ser. No. 62/750,940, filed on Oct. 26, 2018, which are incorporated herein by reference in their entirety.

### STATEMENT REGARDING FEDERALLY SPONSORED RESEARCH OR DEVELOPMENT

Not applicable.

### STATEMENT REGARDING JOINT RESEARCH AGREEMENT

Not applicable.

### BACKGROUND OF THE INVENTION

### 1. Field of the Invention

The invention relates to systems and methods for processing an agricultural product, and in particular, systems and methods for drying an agricultural product.

### 2. Description of Related Art

The use of cannabis for medicinal purposes has increased in recent years. When harvesting cannabis, it is desirable to separate the flower portion of the cannabis plant (which includes the cannabinoid rich buds) from the remainder of the plant (i.e., the stems and leaves).

After the flower portion of the cannabis plant is separated from the stems and leaves, the flower portion must be dried to an appropriate level prior to further processing. The harvest may be dried to a level of 20 percent relative humidity, for example, and it is desirable to do so as quickly as possible (i.e., while still preserving terpenes and flavonoids thereof) so that the dried harvested product may move on to the next steps in the processing. The drying process may include the application of heat and a vacuum to expedite the process.

Products may be harvested and transported such that different containers of such product require different degrees of drying. Current technology for large-scale drying of harvested plant material does not achieve the goal of providing evenly dried material of a chosen moisture content. While uniform moisture content can be achieved by drying the material to a very low moisture content, this may result in the loss of valuable phytochemicals and degrade the organoleptic, nutritive or pharmacological properties of the material.

In a typical plant dryer, air is passed up through a perforated floor of a container holding the material to be dried. However, because of the difficulty of evenly spreading the plant material on the floor, variations in loading density can result in less dense areas that dry quickly and more dense areas that dry slowly. For example, typical plant dryers are not designed so that the flow rate of a blower or fan providing air to the plant dryer matches the flow rate of the air passing through the drying floor. This results in uneven air flow in the plant dryer, particularly when there are areas of varying density or depth of plant material in the plant dryer. Because of this, many plant dryers utilize baffles to direct airflow, which result in drastically varying air flow rates in different areas of the container above the floor and uneven drying of plant material within the container. Floors with baffles are generally not designed to match the output capacity of air systems or fans directing or supplying airflow to the container. The utilization of baffles also makes cleaning the container and floor more difficult as the baffles serve as obstructions.

### BRIEF SUMMARY OF THE INVENTION

A system for drying an agricultural product in accordance with one aspect of the invention described herein includes a container defining an interior, an air system configured to direct an airflow to the container, at least one sensor that is configured to measure at least one parameter, and a control system. The control system is programmed to (a) receive a measurement of the at least one parameter; and (b) generate an air system instruction based on the measurement of the at least one parameter. The air system instruction corresponds with at least one of an air temperature of the airflow, a flow rate of the airflow, and a pressure of the airflow. The air system is configured to adjust at least one of the air temperature of the airflow, the flow rate of the airflow, and the pressure of the airflow based on the air system instruction. The measured parameter may be at least one of temperature, humidity, flow rate, and air pressure, and may correspond with at least one of the interior of the container, the air system, ambient air, and a conduit connecting the air system to the container. The air system instruction may correspond with the speed of a fan that directs airflow to the container. The air system instruction may correspond with the position of a flow control valve that modulates the flow rate of a heated fluid passing through a heat exchanger. The system may include a plurality of containers and air systems similar to the container and air system described above. The control system may include a controller for each air system that is programmed to generate an air system instruction for each air system as described above.

A process for drying an agricultural product in accordance with another aspect of the invention described herein includes steps of: directing airflow to an interior of a container that contains an agricultural product; measuring at least one parameter that corresponds with at least one of the interior of the container, the agricultural product, the airflow, and the ambient air; generating an air system instruction based on the measurement of the at least one parameter, wherein the air system instruction corresponds with at least one of an air temperature of the airflow, a flow rate of the airflow, and a pressure of the airflow; and adjusting at least one of the air temperature of the airflow, the flow rate of the airflow, and the pressure of the airflow based on the air system instruction. The agricultural product may be cannabis or any portion of a cannabis plant. The airflow may be heated prior to being directed to the interior of the container. The airflow may dry the agricultural product so that a moisture content of a first cubic foot sample of the agricultural product is within 1 wt. % of a moisture content of a second cubic foot sample of the agricultural product.

A system for drying an agricultural product in accordance with another aspect of the invention described herein includes a container and an air system. The container includes a floor that defines a plurality of apertures, and the container defines an interior. The air system is configured to direct an airflow to the interior of the container through the plurality of apertures. The apertures are sized and spaced so that a volumetric flow rate of the airflow through the apertures is between 75% to 100% of a maximum volumetric flow rate of the air system. The apertures may be bridge slots. A first flow rate of the airflow through the apertures of a first portion of the floor having an area of one square foot may not vary more than between about 0.1 to 1 ft³/min from a second flow rate of the airflow through the apertures of a second portion of the floor having an area of one square foot, wherein the second portion of the floor does not overlap with the first portion of the floor. The container may be configured to not include baffles to redirect the airflow.

Additional aspects of the invention, together with the advantages and novel features appurtenant thereto, will be set forth in part in the description which follows, and in part will become apparent to those skilled in the art upon examination of the following, or may be learned from the practice of the invention. The objects and advantages of the invention may be realized and attained by means of the instrumentalities and combinations particularly pointed out in the appended claims.

### BRIEF DESCRIPTION OF THE DRAWINGS

FIG. 1 is a perspective view of an exemplary system for drying an agricultural product in accordance with the invention described herein.

FIG. 2 is a schematic view of an air system and heat source of the system of FIG.

FIG. 3 is a perspective view of an exemplary floor of a drying container of the system of FIG. 1.

FIG. 4 is a detail view of a portion of the floor of FIG. 3.

FIGS. 5A-C are bottom, front, and side views of the floor of FIG. 3.

FIG. 6 is a schematic view of an air system and container of the system of FIG. 1.

FIG. 7 is a perspective view of a bridge slot perforation of the floor of FIG. 3.

### DETAILED DESCRIPTION OF EXEMPLARY EMBODIMENTS

In an aspect, the invention described herein is directed to a system for drying one or more agricultural products. The system may be configured to dry agricultural products until a desired humidity level is reached or a desired moisture content of the agricultural products is reached. Suitable agricultural products include, but are not limited to, cannabis plants and components thereof (e.g., stems, stalks, flowers, and/or buds), and the system is capable of simultaneously drying more than one type of agricultural product (e.g., one type of agricultural product may be placed within one container of the system and another type of agricultural product may be placed in another container of the system).

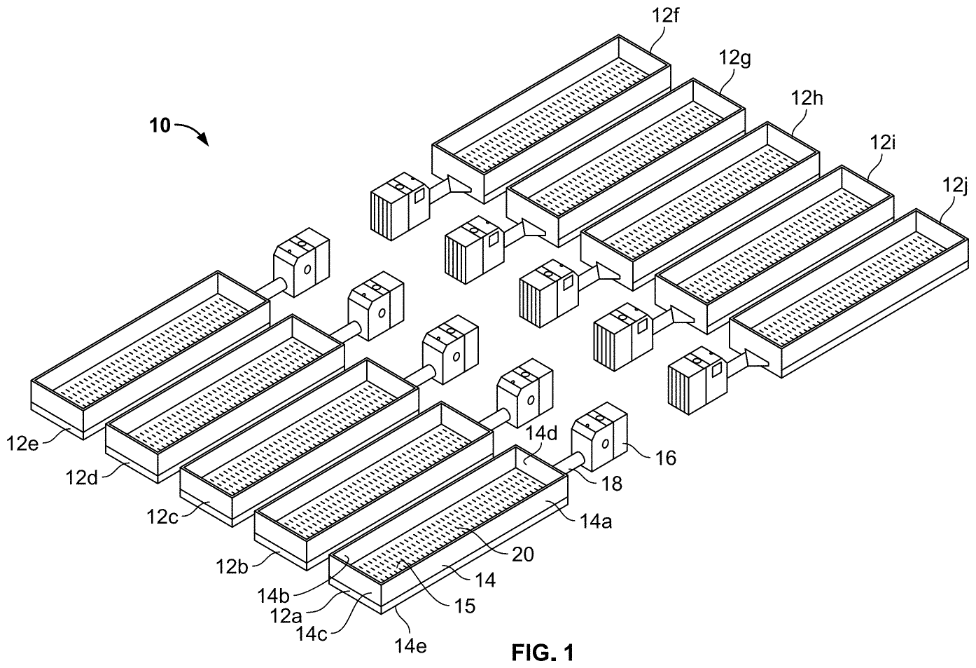

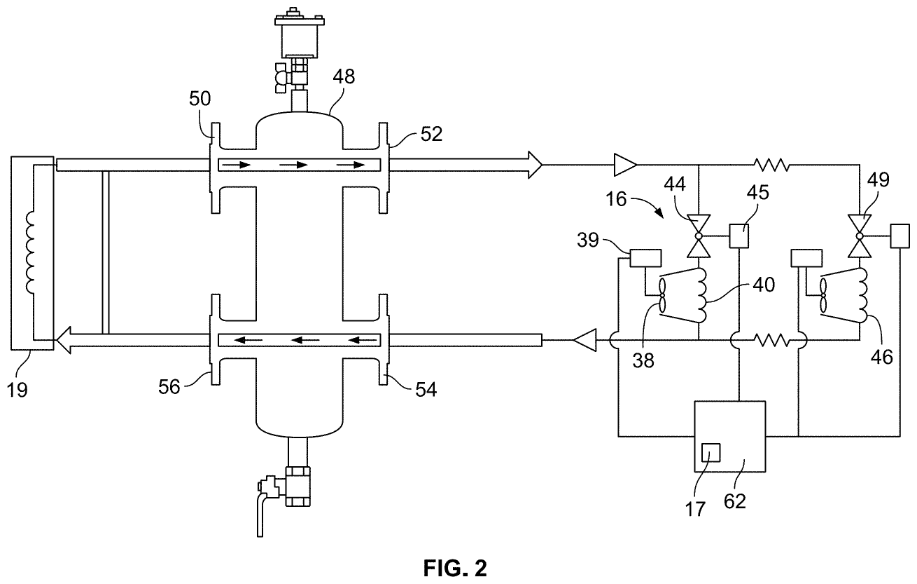

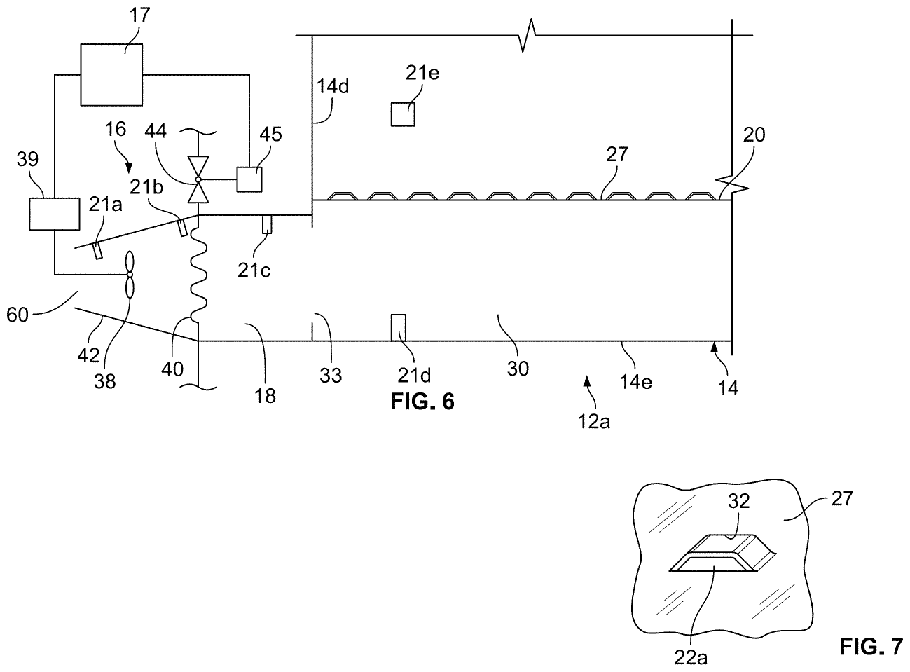

FIG. 1 depicts an exemplary embodiment of a system 10 for drying an agricultural product in accordance with the invention described herein. System 10 includes a plurality of drying units 12a-j. Each drying unit 12a-j is substantially similar. Accordingly, only drying unit 12a is described in detail herein. Drying unit 12a includes a container 14, an air system 16 coupled to the container 14, and a controller 17 (FIG. 6). The container 14 is coupled via a conduit 18 to the air system 16. The air system 16 is configured to direct airflow to an interior 15 of the container 14 via the conduit 18. The air system 16 may heat the airflow in connection with a heat source 19 (FIG. 2) and controller 17, as described in more detail below. Sensors 21a-e (FIG. 6) are configured to measure at least one parameter and to transmit a measurement of the at least one parameter to the controller 17. The controller 17 may be programmed to set and adjust a temperature, a pressure, and/or a flow rate of the airflow of air system 16 in response to at least one of the measurements transmitted to the controller 17 by sensors 21a-e.

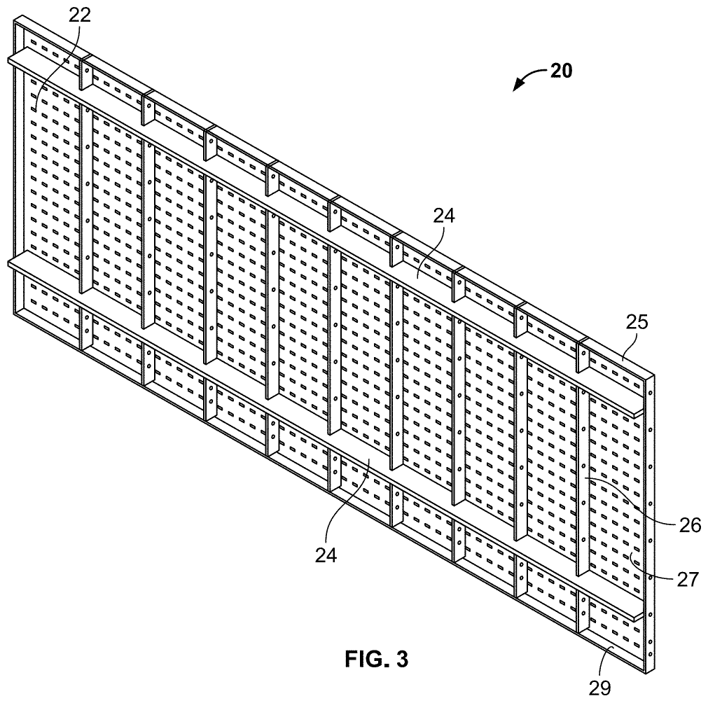

Container 14 includes side walls 14a-b, end walls 14c-d, and a bottom 14e that define interior 15. A floor 20 is positioned inside of interior 15 where it is supported by bottom 14e. Referring to FIG. 3, the underside of floor 20 may include support ribs 24 aligned with a longitudinal axis of the floor 20 and support ribs 26 aligned with a transverse axis of the floor 20. The floor 20 may be formed from aeration planks and may be galvanized. As shown in FIG. 3, floor 20 may be formed from a plurality of aeration planks, one of which is identified as 25, positioned side-by-side. Each aeration plank may include a surface 27, and a flange 29 extending generally perpendicular to the surface 27 around a peripheral edge of the surface 27. The flanges 29 of the aeration planks may form support ribs 26. The flanges 29 may be received by slots in the support ribs 24 to position the aeration planks with respect to each other. The aeration planks may also be joined together, for example, by fasteners or by welding. The flanges 29 and support ribs 24 space the surface 27 above the bottom 14e of container 14 when floor 20 is supported by bottom 14e. A chamber 30 is formed between surface 27 and bottom 14e, as shown in FIG. 6. There may also be a ledge on the side or end walls 14a-d on which floor 20 rest above the bottom 14e to form the chamber 30. Air may flow from air system 16 through conduit 18 and into chamber 30 through an opening 33 in end wall 14d that is aligned with conduit 18, as shown in FIG. 6.

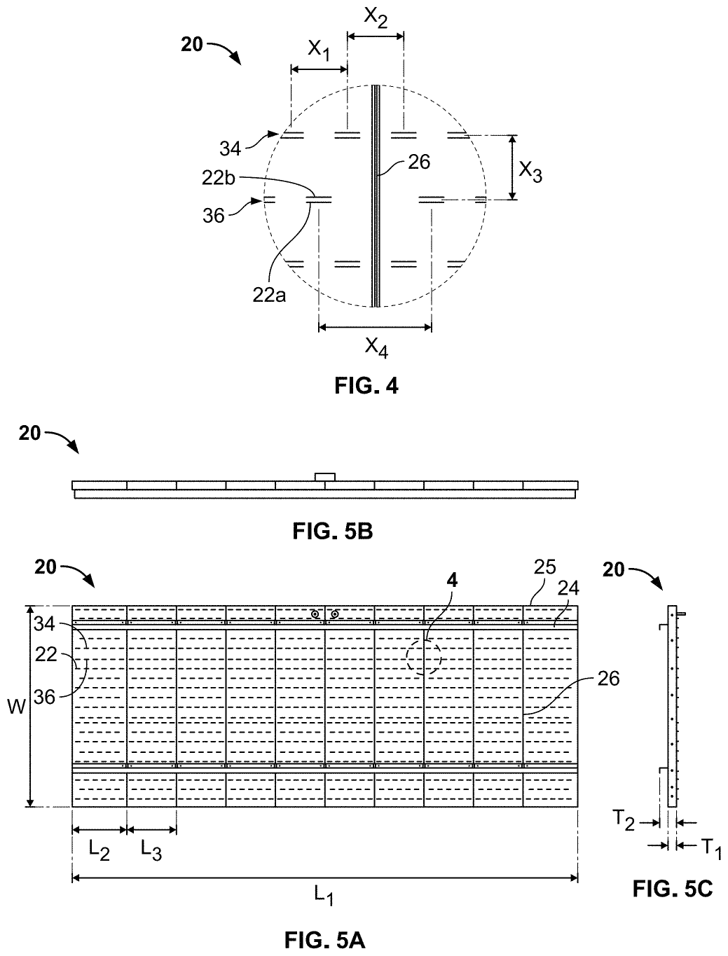

The floor 20 is designed for supporting harvested agricultural products (e.g., cannabis plants or portions of cannabis plants as described above) placed within the interior 15 of container 14. As best shown in FIGS. 3-5, each floor 20 includes a plurality of apertures 22 formed in surface 27 that allow air to flow from the air system 16, through the conduit 18, through the chamber 30, and through the apertures 22 into the interior 15 where the air comes into contact with the agricultural product and dries the agricultural product. The apertures 22 may be bridge slot perforations. As shown in FIG. 7, a bridge 32 extending upward from surface 27 forms the bridge slot perforations between the bridge 32 and the surface 27. One bridge slot perforation or aperture 22a is shown in FIG. 7 with the other bridge slot perforation formed by bridge 32 being on the opposite side of bridge 32 as is generally known in the art. FIG. 4 shows the bridge slot perforation or aperture 22a and the other bridge slot perforation or aperture 22b formed by bridge 32. As shown, there are a plurality of pairs of bridge slot perforations or apertures formed in surface 27 similar to bridge slot perforations or apertures 22a-b. As shown, apertures 22 may be aligned with a longitudinal axis of floor 20 (i.e., extending between end walls 14c-d), and each pair of apertures 22 are spaced apart from other surrounding pairs of apertures 22.

The size of the apertures 22 and the spacing of each pair of apertures 22 from other surrounding pairs of apertures 22 in floor 20 may be balanced so that a volumetric flow rate of the airflow through all of the apertures 22 combined, Q_{floor}, is slightly less than the maximum volumetric flow rate of the air system 16, Q_{air system} (e.g., the maximum rated or tested volumetric flow rate of a fan or blower of the air system 16). For example, the apertures 22 of floor 20 may be sized and spaced so that Q_{floor} may be between 75% to 100% of Q_{air system}, 90% to 100% of Qₐᵢᵣ system, 95% to 100% of Q_{air system}, 97% to 100% of Q_{air system}, or 95% to 99% of Q_{air system}. The apertures 22 in floor 20 may be sized and spaced to provide minimal back pressure (e.g., approximately 200 Pascals) while allowing for an even air flow from the air system 16 in order to permeate the entire surface area of the floor 20 such that agricultural product held within the interior 15 of the corresponding container 14 may be evenly dried. For example, the apertures 22 in floor may be sized and spaced to reduce a pressure of the airflow from the air system 16 flowing through the apertures 22 by a minimal amount. The pressure may be reduced by between approximately 1 to 2000 Pascals, 1 to 1000 Pascals, 1 to 500 Pascals, 100 to 400 Pascals, or approximately 200 Pascals. Airflow flux through any square foot portion of the floor 20 may vary from the airflow flux through any other non-overlapping square foot portion of the floor 20 not more than about 0.1 ft³/min, about 0.2 ft³/min, about 0.3 ft³/min, about 0.4 ft³/min, about 0.5 ft³/min, about 0.6 ft³/min, about 0.7 ft³/min, about 0.8 ft³/min, about 0.9 ft³/min, about 1 ft³/min, about 2 ft³/min, about 3 ft³/min, about 4 ft³/min, about 5 ft³/min, about 6 ft³/min, about 7 ft³/min, about 8 ft³/min, about 9 ft³/min, or about 10 ft³/min. In one embodiment, a first flow rate of the airflow through the apertures 22 of a first portion of the floor 20 having an area of one square foot does not vary more than between about 0.1 to 1 ft³/min from a second flow rate of the airflow through the apertures 22 of a second portion of the floor 20 having an area of one square foot, wherein the second portion of the floor 20 does not overlap with the first portion of the floor 20.

Evenly disbursed airflow through the apertures 22 of floor 20 helps to ensure even drying of any agricultural product contained within the container 14. For example, the system 10 may achieve a variability of less than: about +/−1 wt. %; about +/−0.5 wt. %; about +/−0.25 wt. %; about +/−0.125 wt. %; or about +/−0.0625 wt. % moisture content (on a wet basis or a dry basis) between any cubic foot sample of agricultural product within a given container 14 after a drying cycle is complete. For example, the airflow from the air system 16 passing through the apertures 22 may dry the agricultural product within the container 14 so that a moisture content (on a wet basis or a dry basis) of a first cubic foot sample of the agricultural product is within 1 wt. % from a moisture content (on a wet basis or a dry basis) of a second cubic foot sample of the agricultural product. Each container 14 may also include various other openings and/or internal passageways (not shown) that are not necessarily in floor 20 and that are configured to allow air conveyed from the air system 16 to pass therethrough and to the interior 15 of the container 14.

The interior surfaces of the container 14 and the floor 20 preferably do not include baffles to redirect air flow passing from the air system 16 into the chamber 30 and through the apertures 22. Accordingly, cleanout of the container 14 and of the floor 20 is made easier due to the elimination of baffles, which can act as obstructions. The interior surfaces of the container 14 (including floor 20) may be coated with a food grade finish.

Referring to FIG. 5A, in one exemplary embodiment, the floor 20 has an overall length L1 that may be approximately 115 to 116 inches and a width W of approximately 47 inches. The floor 20 may have a thickness T1 that is the thickness of the surface 27 and flange 29 and a thickness T2 that is the thickness of the surface 27, flange 29, and support ribs 24. T1 may be approximately 1.75 inches and T2 may be approximately 3.6 inches. Further as shown in FIG. 5A, in one exemplary embodiment, floor 20 may include 10 aeration planks 25 positioned side-by-side. The length L2 of each aeration plank 25 on the ends of floor 20 may be approximately 12.6 inches, and the length L3 of the other eight aeration planks 25 may be approximately 11.3 inches. Referring to FIG. 5A, in one exemplary embodiment, there may be approximately 20 rows of apertures with each row extending across the length of the floor 20 and spaced from adjacent rows across the width of the floor 20. The rows may alternate between a row 34 that has approximately 60 pairs of apertures, or 120 apertures, and a row 36 that has approximately 50 pairs of apertures, or 100 apertures. Referring to FIG. 4, the apertures 22 within each row 34 on a single one of the aeration planks 25 may be spaced apart from the center of one pair of apertures 22 to the center of an adjacent pair of apertures 22 a distance X1, which may be approximately 1.9 inches. The apertures 22 within each row 36 on a single one of the aeration planks 25 may be spaced the same distance. Within row 34, the apertures 22 may be spaced apart from the center of one pair of apertures 22 on one aeration plank 25 to the center of an adjacent pair of apertures 22 on another aeration plank 25 a distance X2, which may be approximately 1.9 inches. The spacing between rows 34 and 36 is a distance X3, which may be approximately 2.2 inches. Within row 36, the apertures 22 may be spaced apart from the center of one pair of apertures 22 on one aeration plank 25 to the center of an adjacent pair of apertures 22 on another aeration plank 25 a distance X4, which may be approximately 3.8 inches.

Referring to FIG. 6, the air system 16 includes a fan 38 and a heat exchanger 40 that are positioned within a housing 42. The heat exchanger 40 is configured to receive heated fluid from the heat source 19 as described in more detail below. The air system 16 may further include a flow control valve 44 that is configured to modulate the flow rate of a heated fluid passing through the heat exchanger 40. The fan 38 is positioned within the housing 42 so that it pulls air through an inlet 60 and blows the air through the heat exchanger 40, through the conduit 18, and into the chamber 30 of the container 14. Thus, the incoming air is heated by the heat exchanger 40 before it enters the container 14. The fan 38 has a motor 39, which is electrically coupled to the controller 17, and the flow control valve 44 has a motor 45, which is electrically coupled to the controller 17.

The air system 16 may be configured to produce airflow at a specific temperature or within a specific temperature range (i.e., warmed air) and to convey the air to the container 14 via the corresponding conduit 18. The air system 16 may be configured to produce airflow over a wide range of temperatures. Exemplary adjusted temperature ranges are from ambient temperature to 135° F. (about 57° C.), and the average operating temperature range may be 80° F. to 99° F. (about 27° C. to 37° C.). However, higher or lower temperatures may be utilized if necessary. For example, the air system 16 may be configured to adjust the temperature of airflow therefrom to be 5° C. below the ambient temperature.

For quality assurance purposes, the air system 16 may include one or more air filters (not shown) that serve to prevent contaminants or other undesirable materials from entering the corresponding container 14. Suitable filters include, but are not necessarily limited to, 3X MERV 8 filters. The fan 38 may be a backwards inclined fan that is configured to exhibit high static pressure in order to ensure that the flow rate of air from the air system 16 may be more easily set by the corresponding controller 17. The measurement of airflow from such a backwards inclined fan may be based on Bernoulli and Continuity equations which allow calculation of flow through a conversion nozzle based upon measurement of a static pressure drop across a nozzle. In certain embodiments, the air system 16 may be configured to provide airflow at a rate of at least 3,000 cubic feet per minute.

Referring to FIG. 2, the heat source 19 is connected to the heat exchanger 40 of the air system 16 and to the heat exchangers of the other drying units 12b-j, one of which is identified in FIG. 2 as 46. The heat source 19 may be a boiler that heats the fluid. A hydraulic separator 48 may be positioned between the heat source 19 (i.e., boiler circuit) and the heat exchangers 40, 46 of the drying units 12a-j (i.e., load circuit). The heat exchangers 40, 46 of the drying units 12a-j constituting the load circuit may be connected in parallel as shown in FIG. 2. Heated fluid coming from the heat source 19 may pass through the flow control valve 44 prior to entering the heat exchanger 40. Thus, the flow control valve 44 is operable to regulate the flow rate of the heated fluid through the heat exchanger 40, and thereby regulate the temperature of the airflow that passes through the air system 16 into container 14. Each drying unit 12b-j may include a flow control valve (e.g., the flow control valve 49 shown in FIG. 2) to regulate the flow of heated fluid to heat exchanger 46.

Suitable heat sources, include, but are not necessarily limited to, a heat exchanger 40 fed by a food grade glycol system (i.e., propylene glycol USP/EP, a pharmaceutical grade of monopropylene glycols with specified purity greater than 99.8%) operating at about 180° F. The flow control valve 44 may be a pressure independent flow control valve driven by the motor 45 with instructions from controller 17 to adjust flow in a linear pattern from 0-17 gallons per minute per exchanger and may modulate according to outlet temperature goal and ambient intake temperature. The heat source 19 may be one or more boilers or other sources of heat that are configured to heat the glycol prior to the glycol being provided to the heat exchanger 40. The heated glycol may then enter the heat exchanger 40 where it may transfer heat to airflow exiting air system 16 prior to the airflow entering the interior 15 of the corresponding container 14. There may be a separate heat source 19 for each drying unit 12a-j, or a single heat source 19 that is connected to the heat exchanger 40, 46 of all of the drying units 12a-j as shown in FIG. 2. Further, the heat source 19 may be positioned directly in the air system 16 making the heat exchanger 40 unnecessary (e.g., the heat source 19 may be a burner that heats the air flowing through air system 16). The hydraulic separator 48 may be designed such that each heat exchanger 40, 46 (and thus each corresponding air system 16) is provided with an equal amount of heated fluid as needed and as determined by each corresponding controller 17 in response to measurements taken by one or more sensors 21a-e.

The hydraulic separator 48 may be utilized at a connection point between the heat source 19 or boiler circuit and the load circuit consisting of the heat exchangers 40, 46 of the drying units 12a-j. Flow is directed from the heat source 19 through the hydraulic separator 48 and to the load or distribution circuit where the flow is then directed to the heat exchangers 40, 46 that are each connected to at least one of the plurality of containers 14 of the system 10. The hydraulic separator 48 is configured to manage flow when there may be a difference between the flow rate of the load circuit (i.e., heat exchangers 40, 46) and the flow rate of the boiler circuit (i.e., heat source 19). As shown in FIG. 2, the hydraulic separator 48 has four ports 50, 52, 54, and 56. Port 50 receives heated fluid from the heat source 19, port 52 transfers the heated fluid to the heat exchangers 40, 46, port 54 receives the fluid from the heat exchangers 40, 46, and port 56 transfers the fluid back to the heat source 19. Utilization of the hydraulic separator 48 may allow a constant flow rate to be applied to the boiler circuit independent of the flow rate of the fluid through the heat exchangers 40, 46. In the instance where the flowrate through the heat source 19 (i.e., the primary or boiler circuit) is equal to the flowrate through the heat exchangers 40, 46 (i.e., the secondary or distribution circuit), the flow rate at port 50, Q1, equals the flow rate at port 56, Q4, and the flow rate at port 52, Q2, equals the flow rate at port 54, Q3. Further, the temperature of the fluid at port 50, T1, equals the temperature of the fluid at port 52, T2, and the temperature of the fluid at port 54, T3, equals the temperature of the fluid at port 56, T4. In this case, hot fluid remains near the top of the hydraulic separator 48 and is transferred from the heat source 19 to the heat exchangers 40, 46. Colder fluid is returned to the heat source 19 in an opposite manner at the bottom of the device, and there is little mixing of the fluid passing through the hydraulic separator 48. If the flowrates of the circuits are not the same, the heat flow is affected. In instances where the flowrate of the distribution circuit (i.e., through heat exchangers 40, 46) is higher than the flow rate of the primary or boiler circuit (i.e., through heat source 19), cooler fluid entering port 54 will travel upward through the hydraulic separator 48 and mix with the fluid exiting through port 52, which in turn will result in a lower temperature being returned to the heat exchangers 40, 46. When the flowrate through heat source 19 is higher than the flowrate through heat exchangers 40, 46, fluid entering port 50 will travel downward through the hydraulic separator 48 and mix with the fluid exiting through port 56.

As shown in FIG. 6, sensor 21a is positioned within the air system 16 between the fan 38 and an air inlet 60, sensor 21b is positioned within the air system 16 between the fan 38 and the heat exchanger 40, sensor 21c is positioned within the conduit 18, sensor 21d is positioned within the chamber 30 of container 14, and sensor 21e is positioned within the container 14 above floor 20. The system 10 may include any combination of these sensors 21a-e and may further include sensors positioned outside of the air system 16 and container 14 that are designed to measure ambient air conditions surrounding the air system 16. The sensors 21a-e may measure parameters of the air surrounding the sensor such as air temperature, humidity, airflow rate, airflow velocity, and air pressure. A sensor positioned in the container 14 may further measure the weight of the agricultural product positioned in the container 14. The parameters measured by the sensors 21a-e may correspond with at least one of the interior 15 of the container 14, the air system 16, the ambient air, the conduit 18, and the agricultural product being dried. The sensors 21a-e are electrically coupled to the controller 17 so that the controller 17 can receive measurements of the measured parameters from the sensors 21a-e. The measured parameters may be logged by the controller 17 at various intervals for review, fine-tuning, quality control, and process documentation. The data and measurements collected by the sensors 21a-e may be provided to the controller 17 via wired or wireless data transfer methods.

The sensors 21a-e may be configured to generate or enable the generation by the controller 17 of warnings, alerts, or messages that correspond to the state of the agricultural product or the environment within and/or outside each container 14, air system 16, and conduit 18. These generated warnings, alerts, or messages may be transmitted either via a connection of the sensors 21a-e to the controller 17 or independently of the connection of the sensors 21a-e to the controller 17. Suitable warnings, alerts, or messages include, but are not necessarily limited to: a sound, a light, or an image. For example, an alarm beacon may be coupled to a humidity sensor in the container 14 and/or to the controller 17. The alarm beacon may be configured to signal that there is a problem with a drying process (whether completed or otherwise) so that an operator is immediately notified of the issue.

A control system 62 (FIG. 2) of the system 10 may be configured to automate and control the agricultural product drying process of the system 10. The control system 62 may include the controller 17 of drying unit 12a and other controllers (not shown) of the other drying units 12b-j. The controller 17 and controllers of the other drying units 12b-j may each include a microcontroller that is programmed in order to control the system 10. Each of the drying units 12a-j may have their own controller 17, which may be mounted in any suitable location in the drying unit 12a-j. Further, the control system 62 may consist of a single controller 17 that controls each of the drying units 12a-j.

With reference to the controller 17 of drying unit 12a, the controller 17 may receive a measurement of the parameters measured by at least one of the sensors 21a-e. The controller 17 may be programmed to generate an air system instruction based on the measurement of the parameters, and the air system instruction may correspond with at least one of an air temperature, a flow rate, and a pressure of the airflow that is directed by the air system 16 into the container 14. The air system instruction may correspond with the flow rate of the airflow and the speed of the fan 38 and fan motor 39. In this case, the controller 17 may send the air system instruction to the fan motor 39 to alter the speed of the fan 38 and fan motor 39. The air system instruction may further correspond with the air temperature of the airflow. The air system instruction may further correspond with the flow rate of heated fluid passing through the heat exchanger 40 and/or the temperature of the heated fluid passing through the heat exchanger 40. To alter the air temperature of the airflow exiting the air system 16 and entering container 14, the controller 17 may send the air system instruction to the motor 45 of the flow control valve 44 to alter the position of the flow control valve. Further, the controller 17 may send the air system instruction to the heat source 19 to alter the temperature of the heat source 19.

In one aspect, the humidity level of the air within the interior 15 of the container 14, which may correspond to the moisture content of the agricultural product being dried within the container 14, is controlled by the controller 17. The controller 17 may be programmed to receive a measurement of the humidity level of the air within the interior 15 of the container 14 from the sensor 21e. The controller 17 may be programmed to compare the humidity level to a desired pre-programmed humidity level. The controller 17 may be programmed to generate an air system instruction that is designed to alter the actual humidity level so that it approaches the pre-programmed desired humidity level. For example, if the humidity level is greater than a desired level or if it is not decreasing at a desired rate, the controller 17 may generate an air system instruction that corresponds with an increase in the speed of the fan 38, an increase in the flow rate of the heated fluid through the flow control valve 44 and/or an increase in the temperature of the heat source 19. Likewise, if the humidity level is decreasing at more than a desired or expected rate or as the humidity level approaches the desired level, the controller 17 may generate an air system instruction that corresponds with a decrease in the speed of the fan 38, a decrease in the flow rate of the heated fluid through the flow control valve 44 and/or a decrease in the temperature of the heat source 19. The controller 17 may further adjust the speed of the fan 38, the position of the flow control valve 44, and/or the temperature of the heat source 19 based on measurements of parameters from the other sensors 21a-d. For example, if an actual flow rate measured by sensor 21d is less than expected or desired, the controller 17 may generate an air system instruction that increases the speed of the fan 38. When a desired humidity level within container 14 is reached, the controller 17 may generate an air system instruction that stops fan 38. The controller 17 may control the heat source 19, fan 38, and flow control valve 44 based on information received from the sensors 21a-e in order to provide a stable and precise outlet temperature of the airflow entering container 14 with minimal fluctuations from a set point regardless of the ambient conditions. The controller 17 may further be programmed to adjust the heat source 19, fan 38, and flow control valve 44 based on a measured weight of the agricultural product within the container 14 (i.e., as the weight decreases, the moisture content of the agricultural product decreases).

The controller 17 may be programmed to determine a preferred temperature for the air flow exiting the air system 16 and entering container 14 based at least in part on measurements of ambient air conditions measured by a sensor. For example, if ambient air conditions are at 15° C. and 48% relative humidity, the controller 17 may adjust the flow control valve 44 and/or heat source 19 so that the air flow exiting the air system 16 has a temperature of 21° C. in order to achieve a relative humidity level of less than 20%.

The control system 62 may also allow for manual operation of the components of the system 10 rather than (or in addition to) being programmed to automate the operation. The control system 62 may be programmed based on actionable field data, production testing, measurements of one or more parameters, and real-time monitoring data, which in turn may be collected by the sensors 21a-e. Controller 17 and the controllers of the other drying units 12b-j may be operated individually in order to separately control the drying process for each respective drying unit 12a-j. Alternatively, the controllers 17 may be operated together in order to simultaneously control the drying process for each respective drying unit 12a-j in the same manner. For example, changes to the drying cycle process may be made simultaneously to the controller 17 of each drying unit 12a-j in order to create consistent and repeatable drying operations for each drying unit 12a-j. As yet another alternative, changes to the drying cycle process may be individually tailored to each drying unit 12a-j, which may result in improved energy efficiencies (e.g., the airflow in one drying unit 12a-j may be stopped when a desired humidity level is reached as sensed by sensor 21e). Such individual control may be particularly useful when different agricultural products are simultaneously dried in separate drying units 12a-j of system 10. The control system 62 may include a personal computer, server, smartphone, or other computing device that is operable to communicate instructions to and receive information from the controller 17 and the controllers of the other drying units 12b-j.

The container 14 may include one or more agitators (not shown) that are configured to agitate agricultural product contained within the container 14. Suitable agitators include, but are not limited to, mechanical agitators. Alternatively, agitation may be provided by pulses of air provided by the air system 16. Each container 14 may also include a removable cover plate (not shown) that may be positioned on the top of the container 14 and that serves to protect the interior of the container 14 and its contents from being contaminated by pests and/or debris. Each container 14 may also include a built-in tarp (not shown) that enables the unloading of any contents held in the interior of the container 14 and that alleviates the need to elevate any portion of the container 14 in order to remove the contents. The tarp may be similar to those used for roll-off containers and may be movable from a covered position to an open position. In the covered position, the tarp may seal the interior of the container 14 to prevent pests, rain, and debris from entering the interior. The interior surfaces of each container 14 may also include measurement markings (not shown) that enable the visual determination of the approximate load size contained within the container 14.

The containers 14, air systems 16, and conduits 18 may include mechanisms (not shown) that allow for the removable attachment of containers 14 to conduits 18 and conduits 18 to air systems 16 (e.g., quick attachment and detachment plates, etc.). Each container 14 may be movable (e.g., they may include wheels). Alternatively, the containers may be movable by industrial forklift trucks or other vehicles. For example, each container 14 may include forklift pockets to enable the container 14 to be moved by industrial forklifts. The top of each container 14 may be open to the environment as shown in FIG. 1. Alternatively, the top of each container 14 may be enclosed (not shown), for example, with a removable cover. Each air system 16 may include forklift pockets (not shown) (e.g., double forklift pockets) and/or a lift point on top thereof in order that each air system 16 is movable with industrial forklift trucks or other industrial moving equipment.

Although system 10 is shown with a plurality of drying units 12a-j, the system 10 may alternatively include only one drying unit 12a. Additionally, although each drying unit 12a-j is shown with a single air system 16, each drying unit 12a-j, or certain drying units 12a-j, may alternatively include multiple air systems 16. Furthermore, instead of each drying unit 12a-j having a single air system 16 as shown, all of the drying units 12a-j may instead share a single, common air system 16. And although each drying unit 12a-j of system 10 may include a separate controller 17, all of the drying units 12a-j may alternatively share a single, common controller that is programmed to send air system instructions to the air system 16 of each drying unit 12a-j.

In another aspect, the invention described herein is directed to a process for drying an agricultural product, including but not limited to cannabis plants and components thereof. In an embodiment, the process can be performed utilizing system 10. The process includes the steps of: directing airflow to the interior 15 of the container 14 that contains an agricultural product; measuring at least one parameter that corresponds with at least one of the interior 15 of the container 14, the agricultural product, the airflow, and the ambient air; generating an air system instruction based on the measurement of the at least one parameter, wherein the air system instruction corresponds with at least one of an air temperature of the airflow, a flow rate of the airflow, and a pressure of the airflow; and adjusting at least one of the air temperature of the airflow, the flow rate of the airflow, and the pressure of the airflow based on the air system instruction. The airflow may further be heated by the heat exchanger 40 prior to entering container 14. The air system 16 may direct the airflow to the interior 15 of the container 14. The sensors 21a-e may measure the at least one parameter. The controller 17 may generate the air system instruction. The air system 16 and/or heat source 19 may adjust the air temperature, flow rate, and/or air pressure of the airflow. The drying process can be performed on an agricultural product contained in only one of the drying units 12a-j. Alternatively, the drying process can be simultaneously performed on one or more agricultural products contained in a plurality of the drying units 12a-j.

The process of the invention is demonstrated by the following exemplary and non-limiting examples:

### Example 1

Cannabis or hemp is placed in the interior 15 of the container 14 of the system 10. Airflow is provided from the air system 16 at a drying temperature of about 26° C. (about 80° F.). The airflow is maintained at this temperature until a desired temperature and humidity (e.g., 0-30% or 10-20%) are achieved within the container 14. For example, a humidity of 10-12% may be ideal for bulk extraction materials. As another example, it may be desirable for hemp or cannabis materials to be dried to less than 5% or less than 1%. The temperature inside the container 14 may be reduced gradually to ambient air temperature over a period of time which may vary depending on the amount of heat provided and the desired humidity level. The temperature and humidity inside the container 14 may be measured by the sensor 21e as described above.

### Example 2

Cannabis or hemp is placed in the interior 15 of the container 14 of the system 10. One or more sensors 21e within the container 14 measure humidity, temperature, and the weight of the cannabis or hemp and transmit the measurements to the controller 17. Airflow may be decreased as a weight of the cannabis or hemp held in the container 14 decreases due to the drying process. The reduction in airflow prevents the displacement of the cannabis or hemp and maximizes energy efficiency due to the reduction in power required as a result of reducing the airflow. The cannabis or hemp may be agitated with a mechanical agitator or with pulses of air provided by the corresponding air system 16 at time intervals that are predetermined or that are based upon measurements provided by the one or more sensors 21e within the container 14.

From the foregoing it will be seen that this invention is one well adapted to attain all ends and objectives herein-above set forth, together with the other advantages which are obvious and which are inherent to the invention.

Since many possible embodiments may be made of the invention without departing from the scope thereof, it is to be understood that all matters herein set forth or shown in the accompanying drawings are to be interpreted as illustrative, and not in a limiting sense.

While specific embodiments have been shown and discussed, various modifications may of course be made, and the invention is not limited to the specific forms or arrangement of parts and steps described herein, except insofar as such limitations are included in the following claims. Further, it will be understood that certain features and subcombinations are of utility and may be employed without reference to other features and subcombinations. This is contemplated by and is within the scope of the claims.

What is claimed and desired to be secured by Letters Patent is as follows:

1. A system for drying an agricultural product, comprising:
a container defining an interior;
an air system configured to direct an airflow to the container;
at least one sensor that is configured to measure at least one parameter; and
a control system programmed to (a) receive a measurement of the at least one parameter; and (b) generate an air system instruction based on the measurement of the at least one parameter, wherein the air system instruction corresponds with at least one of an air temperature of the airflow, a flow rate of the airflow, and a pressure of the airflow,
wherein the air system is configured to adjust at least one of the air temperature of the airflow, the flow rate of the airflow, and the pressure of the airflow based on the air system instruction.

2. The system of claim 1, wherein the at least one parameter corresponds with at least one of the interior of the container, the air system, ambient air, and a conduit connecting the air system to the container.

3. The system of claim 1, wherein the at least one parameter is selected from the group consisting of temperature, humidity, flow rate, and pressure.

4. The system of claim 1, wherein the air system instruction corresponds with the flow rate of the airflow.

5. The system of claim 1, wherein the air system comprises a fan, and wherein the air system instruction corresponds with a speed of the fan.

6. The system of claim 1, wherein the air system instruction corresponds with the air temperature of the airflow.

7. The system of claim 1, wherein the air system comprises a heat exchanger, and wherein the air system instruction corresponds with at least one of a flow rate of heated fluid passing through the heat exchanger or a temperature of the heated fluid.

8. The system of claim 7, wherein the air system further comprises a flow control valve configured to modulate the flow rate of the heated fluid passing through the heat exchanger, and wherein the air system instruction corresponds to a position of the flow control valve.

9. The system of claim 7, further comprising a heat source that is configured to heat the heated fluid passing through the heat exchanger.

10. The system of claim 9, further comprising a hydraulic separator connected between the heat source and the heat exchanger.

11. The system of claim 10, further comprising a plurality of containers and a plurality of air systems each configured to direct an airflow to at least one of the containers, wherein each of the air systems comprises a heat exchanger that is in fluid communication with the hydraulic separator.

12. The system of claim 1, further comprising a plurality of containers, a plurality of air systems each configured to direct an airflow to at least one of the containers, and a plurality of sensors each configured to measure at least one parameter, wherein the control system is programmed to receive a measurement of the at least one parameter from each of the sensors, and wherein the control system is programmed to generate a plurality of air system instructions based on the measurement from each of the sensors, wherein each of the air system instructions corresponds with at least one of an air temperature, a flow rate, and a pressure of the airflow in one of the air systems, and wherein each of the air systems is configured to adjust at least one of the air temperature of the airflow, the flow rate of the airflow, and the pressure of the airflow based on one of the air system instructions.

13. The system of claim 12, wherein the control system comprises a plurality of controllers each associated with one of the air systems, and wherein each controller generates the air system instruction for one of the air systems.

14. The system of claim 1, wherein the container comprises a floor that defines a plurality of apertures, wherein the air system is configured to direct the airflow to the interior of the container through the plurality of apertures.

15. The system of claim 14, wherein the apertures are bridge slots.

16. The system of claim 14, wherein the apertures are sized and spaced so that a volumetric flow rate of the airflow through the apertures is between 75% to 100% of a maximum volumetric flow rate of the air system.

17. The system of claim 16, wherein the apertures are sized and spaced so that a volumetric flow rate of the airflow through the apertures is between 90% to 100% of a maximum volumetric flow rate of the air system.

18. The system of claim 14, wherein the apertures are sized and spaced to reduce a pressure of the airflow flowing through the apertures by approximately 200 Pascals.

19. The system of claim 14, wherein a first flow rate of the airflow through the apertures of a first portion of the floor having an area of one square foot does not vary more than between about 0.1 to 1 ft³/min from a second flow rate of the airflow through the apertures of a second portion of the floor having an area of one square foot, wherein the second portion of the floor does not overlap with the first portion of the floor.

20. The system of claim 1, wherein the container does not include baffles to redirect the airflow.

21. A process for drying an agricultural product, the process comprising:
directing airflow to an interior of a container that contains an agricultural product;
measuring at least one parameter that corresponds with at least one of the interior of the container, the agricultural product, the airflow, and the ambient air;
generating an air system instruction based on the measurement of the at least one parameter, wherein the air system instruction corresponds with at least one of an air temperature of the airflow, a flow rate of the airflow, and a pressure of the airflow; and
adjusting at least one of the air temperature of the airflow, the flow rate of the airflow, and the pressure of the airflow based on the air system instruction.

22. The process of claim 21, wherein the agricultural product is cannabis.

23. The process of claim 21, wherein the air system instruction corresponds with a speed of a fan that directs the airflow to the interior of the container.

24. The process of claim 21, further comprising heating the airflow, and wherein the air system instruction corresponds with at least one of a flow rate of a heated fluid passing through a heat exchanger or a temperature of the heated fluid.

25. The process of claim 21, wherein the airflow dries the agricultural product so that a moisture content of a first cubic foot sample of the agricultural product is within 1 wt. % of a moisture content of a second cubic foot sample of the agricultural product.

26. A system for drying an agricultural product, comprising:
a container comprising a floor that defines a plurality of apertures, wherein the container defines an interior; and
an air system configured to direct an airflow to the interior of the container through the plurality of apertures, wherein the apertures are sized and spaced so that a volumetric flow rate of the airflow through the apertures is between 75% to 100% of a maximum volumetric flow rate of the air system.

27. The system of claim 26, wherein the apertures are sized and spaced so that a volumetric flow rate of the airflow through the apertures is between 90% to 100% of a maximum volumetric flow rate of the air system.

28. The system of claim 27, wherein the apertures are sized and spaced so that a volumetric flow rate of the airflow through the apertures is between 95% to 100% of a maximum volumetric flow rate of the air system.

29. The system of claim 26, wherein the apertures are bridge slots.

30. The system of claim 26, wherein the apertures are sized and spaced to reduce a pressure of the airflow flowing through the apertures by approximately 200 Pascals.

31. The system of claim 26, wherein a first flow rate of the airflow through the apertures of a first portion of the floor having an area of one square foot does not vary more than between about 0.1 to 1 ft³/min from a second flow rate of the airflow through the apertures of a second portion of the floor having an area of one square foot, wherein the second portion of the floor does not overlap with the first portion of the floor.

32. The system of claim 26, wherein the container does not include baffles to redirect the airflow.

33. The system of claim 26, wherein the container further comprises a bottom that is coupled to at least one side wall, and wherein the floor is removably positioned above the bottom.
